(19) United States
(12) Patent Application Publication
(10) Pub. No.: US 2021/0007189 A1
(43) Pub. Date: Jan. 7, 2021

(54) INDUCTION HEATED HAND TOOL CONTAINER

(71) Applicant: Nelson Walter MONTEIRO, Barrie (CA)

(72) Inventor: Nelson Walter MONTEIRO, Barrie (CA)

(21) Appl. No.: 16/979,385

(22) PCT Filed: Mar. 15, 2019
(86) PCT No.: PCT/CA2019/050325

§ 371 Date: Sep. 9, 2020

Related U.S. Application Data
(60) Provisional application No. 62/644,426, filed on Mar. 17, 2018.

(51) Int. Cl. H05B 6/14; H05B 6/04; H05B 6/06; H05B 6/44; B25H 3/02

(52) U.S. Cl. CPC H05B 6/14; H05B 6/04; H05B 6/065; H05B 2213/05; B25H 3/02; H05B 2213/07; H05B 6/44

(57) ABSTRACT

A tool storage device with a base having a working surface on which to place tools and an induction coil located remotely from the working surface and connected to an alternating current power source. The induction coil is located to be magnetically coupled to a tool located on the working surface upon application of the alternating current and thereby induces a heating effect within the tool to elevate the temperature of the tool.

### FIELD OF THE INVENTION

The present invention relates to tool storage devices

### DESCRIPTION OF THE PRIOR ART

In cold environments, metal hand tools such as wrenches, ratchets, pliers, etc. are cold to hold especially in freezing conditions. With many jobs related with mechanics, plumbing, electrical and construction, gloves cannot always be worn for numerous reasons, including the need for precision when removing or replacing a fastener that can only be achieved with a bare hand/fingers, the lack of space to fit a hand and glove into to use a tool, or working with fluids could soak the gloves, leaving the user in an uncomfortable situation. Having to work with cold tools without consistent relief of warmth is not only uncomfortable but can lead to decreased muscle performance, Increased risk of frostbite, Pernio or Raynaud's disease, and painful cracks in finger tips. Using the tools that are required to finish a job but at the same time are causing discomfort, clearly reduces overall productivity.

It has been proposed to provide a heated tool carrier to heat the tools to a comfortable temperature. U.S. Pat. No. 5,276,310 shows heating sheets coated with Ti02 to generate heat when connected to electrical power. However, the heating effect depends on the integrity of the coating which is inevitably exposed to the impact of and abrasion from the tools.

U.S. Pat. No. 7,170,035 shows a construction box which includes a strip or cable heater to elevate the temperature within the box. However the box needs to be enclosed for effective heating.

In both of these patents the heating effect is provided to the entire container and transferred by conduction to the tools, which requires significant energy, even where only a few tools are in the container. As tools are typically used outdoors and in remote locations, the supply of adequate energy to effect heating over a sufficient period is a significant challenge.

It is therefore an object of the present invention to obviate or mitigate the above disadvantages.

### SUMMARY OF THE INVENTION

In general terms, the present invention provides a tool storage device with a base having a working surface on which to place tools. An induction coil is located remotely from the working surface and is connected to an alternating current power source. The induction coil is located to be magnetically coupled to a tool located on the working surface upon application of the alternating current which induces a heating effect within the tool to elevate its temperature.

Preferably, the exterior/interior walls and base of the storage device are made of a plastics material, such as ABS, PVC, Acrylic, etc., and the metal objects (hand tools) placed on or inside will be physically separated from the induction heater element by the plastics to avoid direct contact between the induction coil and the tool. The metal objects placed on the working surface will be heated and not the base itself. This allows the storage device to be efficient and lightweight and also to be energy efficient in that only the tool is heated and not the storage device itself.

The storage device may be formed as a container with a base and side walls and may be insulated and have closable lids to help maintain temperatures of the tools. The container can come in many hand-held sizes, so that they can slide into narrow areas (such as fitting into a tool bag, or low enough to slide under a low-raised vehicle).

The device can also be manufactured as a placement mat to be placed in to a drawer or toolbox, a tool storage board, or a pouch or pocket in which to place hand tools. Accessories can also be developed to specifically work with the storage device, such as hand-held components formed as comfortably shaped iron slugs for warming hands, or accessories to transfer heat into items that are not metal such as a metallic sleeve to contain glue or caulking that would otherwise be solidified by the cold.

In one embodiment, the storage device incorporates a switching circuit between a connection to a DC power source, such as a rechargeable battery or connection to a vehicle battery, and the induction coil. The switching circuit converts the DC power to an alternating current.

The storage device may also include a controller and temperature sensor(s). The controller sets or utilizes the temperature sensor(s) to maintain the desired minimum temperature of the tools placed in the container. In one embodiment, the power source (battery) for the heated tray/box may be removed for remote charging or can be plugged in and charged by an AC or DC source. In another embodiment, the temperature is sensed within the container and maintained at a set minimum temperature without the variability of a controller.

### BRIEF DESCRIPTION OF THE DRAWINGS

The features of the invention will become more apparent in the following detailed description in which reference is made to the appended drawings wherein:

FIG. 1 shows a plan view of a tool mat that is used as a base of a tool storage device.

FIG. 2 shows a plan view of a tool storage device with a controller and power source.

FIG. 3 is a perspective the embodiment of FIG. 2 with covers to enclose the working surface of the tool storage device.

FIG. 4 is a perspective view of the embodiment FIG. 1 configured as a tool storage board,

FIG. 5 is a view similar to FIG. 4 of a further embodiment, and

FIG. 6 is a schematic circuit diagram of a switching circuit used in the tool storage device of FIG. 2.

### DETAILED DESCRIPTION OF THE INVENTION

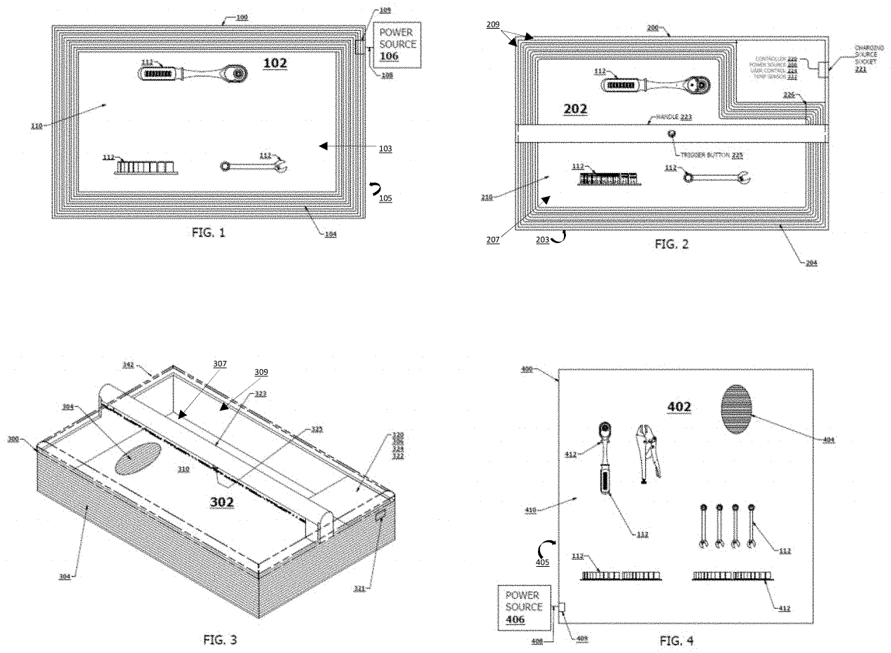

Referring first to FIG. 1, tool storage device 100 is configured as a mat 102. The mat 102 may be used on a bench or floor, as a liner for a drawer or tool chest, or, as discussed in further detail below with reference to FIG. 4 as a wall mounted board. The mat 102 has an upwardly directed working surface 103 and an oppositely directed underside 105 and provides a heated environment 110 for hand tools 112 on the working surface 103 and within the periphery of the mat. Hand tools 112, are for example, ratchet and sockets, wrenches, pliers, hammers, and other hand tools used on repair, maintenance or construction sites that usually are made from a magnetic material such as steel or a steel alloy. The mat is made from a non magnetic material, for example a plastics material, such as ABS, PVC, acrylic, etc.

In the illustrated embodiment, tool mat 102 incorporates a heating element 104 that is configured as an induction coil wound in the plane of the mat 102. The heating element 104 is located on the underside 105 receives electrical power from a power source 106 through cable connection 108. Optionally, tool mat 102 may include a socket 109 such that a cable 108 may be disconnected from tool mat 102. The power source 106 provides a time varying, or alternating, electrical current to the heating element 104. Heating element 104 in this example, may operate continually or intermittently while connected to power source 106.

Heating element 104 may be a low-powered heating unit designed for continual operation such that temperature of tools located within the environment 110 within mat 102 is maintained below an acceptable comfort level, typically less than 50° C. and preferably between 25° C. and 30° C. The heater element 104 is wound as an induction coil wound from, for example, a magnet wire, copper wire, wire strand, Litz wire, that provides a magnetic circuit passing through metal objects placed on the mat 102.

In use, the tools 112 are placed on the working surface 103 of the mat 102 when not being used and, with the power source connected, a magnetic field is induced that passes through the hand tools 112. The alternating magnetic field induces a heating effect in the hand tools 112 to elevate their temperature. The mechanic using the hand tools therefore can pick up the required tool from the mat 102 and avoid the discomfort of using the tool at low ambient temperatures. When the tool is replaced, the tool is again magnetically coupled to the heating element 104 and its temperature elevated. By utilising induction heating effect and the magnetic characteristics of the material of the hand tools 112, localised and direct heating of the tool is provided without the necessity of heating an enclosed volume around the hand tools 112.

In the embodiment of FIG. 2 the storage device 200 is in the form of a tray 202 that has a base 207 and upstanding side walls 209. Tray 202 provides a heated environment 210 for tools 112 within the tray 202. Tool tray 202 has a heating element 204 in the form of an induction coil incorporated in the underside 203 of the base 207.

The heating element 204 is controlled by a controller 220 located in one corner of the base 207. Controller 220 includes a temperature sensor 222 and, optionally, a user control 224 that allows a user to set a desired minimum or maximum temperature for hand tools 112 within the environment 210. The temperature sensor(s) may include the use of Infrared Sensors, Thermistors, thermocouplers, and/or other methods of sensors known in the industry that can measure the temperature of the hand tools 112 as they are heated.

Controller 220 receives power from a power source 206, which is a removable rechargeable battery that installs into the power source 206. Tool tray may include a charging socket 221 so that the removable battery in the power source 206 can be recharged by being plugged into another AC or DC source. The power source includes a switching circuit, described more fully below, to convert the DC battery source provided by the battery to an alternating current to induce heating effect within the tools.

User control 224 may also include an on/off switch to activate and deactivate controller 220 and/or induction heater 204.

Controller 220 utilizes temperature sensor 222 to measure temperature of tools within the environment 210 and compares the measured temperature with the desired minimum temperature. and operates to connect and disconnect power to heater 204 to maintain the temperature of the environment 210 at the desired temperature.

In operation, as the observed temperature of tools 112 within the environment 210 falls below the desired temperature (set by user control 224), controller 220 connects power to induction heater 204 through cable 226. As temperature rises above the desired temperature, controller 220 disconnects heater 204 from power source 206.

The storage device 200 includes a handle 223 to lift the tray, may incorporate a trigger button 225 mounted in the handle 223. The trigger button 225, allows user to maximize heat in the heated environment 210 when trigger button 225 is depressed, bypassing the original set temperature of the user control 224. The embodiment and/or handle may also incorporate a lamp, such as LED(s) to view tools in the dark. The handle of the tool tray could also be heated, though not necessarily by induction heating.

FIG. 3 shows a tool storage device 300 that is in the form of a tray 302 similar to that shown in FIG. 2. The tray 302 provides a heated environment 310 for tools 112 within tray 302. Induction heated Tray/Box 302 has a heater 304 that is controlled by a controller 320. Controller 320 includes a temperature sensor 322. Controller 320 receives power from a power source 306 and operates to connect and disconnect power to heater 304 to maintain temperature of hand tools 112 within the environment 310.

Hinged or non-hinged lids 342 are attached to tray/box 302 so that induction heated environment 310 retains heat and prevents cooling of hand tools 112 from cold elements outside of induction heated environment 310.

As can be seen in FIG. 3, the heating element 304 extends about the periphery of the base 307 and also up the side walls 309 to increase the density of the magnetic field in the heated environment 310.

FIG. 4 shows a further embodiment of a tool storage device 400 that is in a configuration of a heated tool board 402. Heated tool board 402 provides an induction heated environment 410 for hand tools 112 within the tool board area. The hand tools 112 can be temporarily mounted to the induction heated environment using mounts 412 such as hooks, platforms, clamps, or other fasteners.

In the illustrated embodiment, the induction heated tool board has a heater element 404 (shown partially in figures) on the underside 405 that receives power from a power source 406 through cable connection 408. The power source provides a time varying, or alternating, electrical current to the heater element 404. Heater 404 in this example may not be thermostatically controlled and operates continually or intermittently while connected to the power source 406. Heater 404 may be a low-powered heating unit designed for continual operation such that temperature environment 410 within board 402. The heater element 404 is wound as an induction coil and wound from, for example, magnet wire, wire strand, litz wire, or other source of coil that provides a magnetic circuit into metal objects placed on the tool board. Optionally, the tool board 402 may include a socket 409 such that a cable 408 may be disconnected from the tool board 402, or to link numerous tool boards together. As described with respect to FIGS. 2 and 3, the power source may also incorporate a rechargeable battery that permits heating of tools within the environment 410 in the absence of a source of mains power. A switching circuit to convert DC power from the battery to the coil 404 is incorporated in to the board 402 which also facilitates the use of the battery of a vehicle that is being worked upon to supply power the the board.

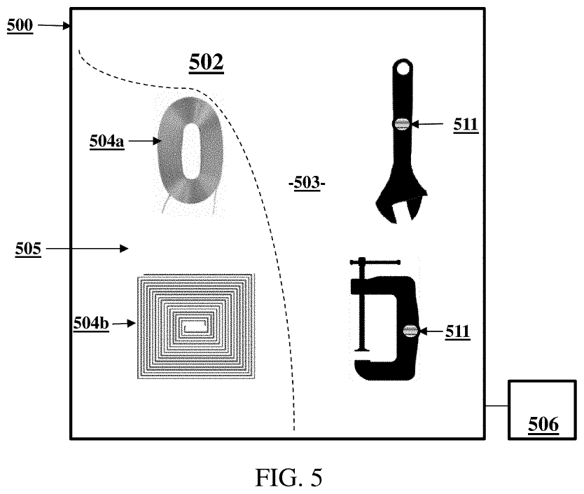

In each of the above embodiments, the heating element is described as a single coil arranged about the periphery of the storage device. Alternatively, as shown in FIG. 5, a number of discrete coils can be arranged about the working surface of the base to provide localised heating in select areas. Referring therefore to FIG. 5, a tool board 500 similar to the embodiment of FIG. 4 is shown. It will be appreciated that the same arrangement may be utilised with the mat shown in FIG. 1 and the tray shown in FIGS. 2 and 3.

A number of coils 504a, 504b etc. are placed over the extent of the underside 505 of the board 502 and connected to a power source 506. The shape of the coils 504 may be varied to suit different applications. For example, an elongate coil as shown at 504a may be used where an elongate tool such as a wrench or screwdriver is to be placed, and a square coil 504b may be used to provide for placement of a bulkier tool such as a puller or C-clamp.

The working surface 503 is marked with the outline of the coil or with the outline of a specific tool to indicate the optimum position of a tool and enhance the efficacy of the coil. To minimise power consumption, switches 511 are located on the working surface to determine the presence of a tool within a specific area. The switches 511 control the power from the power source 506 to the respective coils so the coil is isolated when the tool is removed. The switches 511 can be surface mounted mechanical switches or proximity switches incorporated in the board 502 and responsive to the presence of a tool. By supplying energy only to the coils having a tool in position, the overall energy consumption is reduced.

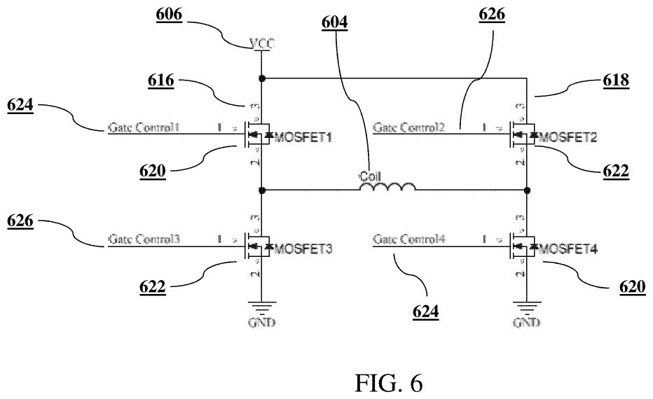

As noted above, the power supply to the heating element 504 includes a switching circuit to supply AC power to the induction coil. The switching circuit is shown in FIG. 6 and is arranged as a bridge circuit between the power source 606 and ground. The coil 604 is located between two branches 616, 618 of the bridge and current flow in each branch controlled by a pair of switches 620 622. The switches are controlled by gate signals 624, 626 which open and close respective ones of the switches 620, 622.

In the first half cycle, switches 620 in each branch are opened by gate signal 624 and the switches 622 remain closed. Current flows from branch 616 across the coil to branch 618. During the next half cycle, the gate signals are reversed and current flows from the branch 618 to the branch 616. An AC current is thus supplied to the coil 604 to provide a varying magnetic field and an inductive heating effect in the tool. A frequency of between 25 khz and 50 khz is believed to be satisfactory.

In the embodiments of FIGS. 2 and 3, the heating element 204/304 is disposed in the base of the container 202/302 and may also be disposed on the upstanding sidewalls of the container to increase the magnetic coupling. In each embodiment, the magnetic coupling through the tool may be enhanced by the placement of iron slugs attached on the under sides of induction coil, or aluminum or an electromagnetic shielding material surrounding the sides of the coil to direct induction heating inward of container.

It will be appreciated that the heating effect is produced within the tools by virtue of the iron content of the tool and therefore effectively only heats the tool rather than the entire environment containing the tool. Energy consumption is thus reduced and the heating effect is directly in to the tool rather than the surroundings.

What is claimed is:

1. A tool storage device with a base having a working surface on which to place tools, an induction coil located remotely from the working surface and connected to an alternating current power source, said induction coil located to be magnetically coupled to a tool located on the working surface upon application of the alternating current and thereby induce a heating effect within the tool to elevate the temperature of the tool.

2. The tool storage device of claim 1 including a power source to supply power to said induction coil.

3. The tool storage device of claim 2 wherein said power source includes a DC battery and a switching circuit to convert output of said DC battery to an AC supply to said induction coil.

4. The tool storage device of claim 3 wherein said DC battery is removably mounted on said storage device.

5. The tool storage device of claim 3 wherein said DC battery is rechargeable.

6. The tool storage device of claim 3 wherein an electrical connector is provided on said device to connect said power supply to an external power source.

7. The tool storage device of claim 1 including a controller to monitor temperature of a tool located on said working surface and control supply of the power to said induction coil to maintain a predetermined temperature of said tool.

8. The tool storage device of claim 7 wherein said predetermined temperature is adjustable.

9. The tool storage device of claim 7 including a switch to interrupt supply of power to said induction coil.

10. The tool storage device of claim 1 wherein said induction coil extends about the periphery of said base.

11. The tool storage device of claim 10 wherein walls are upstanding from said base and an induction coil extends around said walls.

12. The tool storage device of claim 1 wherein a plurality of induction coils are distributed about said base.

13. The tool storage device of claim 12 wherein each of said coils is connected to said power supply by a respective switch to provide selective operation of said coils.

14. The tool storage device of claim 13 wherein a least one of said switches is responsive to the presence of a tool on said working surface.

15. The tool storage device of claim 1 wherein said base is made of a plastics material.

16. The tool storage device of claim 1 wherein said induction coil is located on the opposite side of said base to said working surface.

17. The tool storage device of claim 1 including an upstanding peripheral wall extending about said base.

18. The tool storage device of claim 17 including a lid secured to said peripheral wall.
